(19) United States
(12) Patent Application Publication
(10) Pub. No.: US 2023/0417354 A1
(43) Pub. Date: Dec. 28, 2023

(54) UNIVERSAL HIGH-PRESSURE FITTINGS FOR COMPOSITE PIPES

(71) Applicant: Composite Fluid Transfer LLC, Kilgore, TX (US)

(72) Inventor: Christopher L. Taylor, Winona, TX (US)

(73) Assignee: Composite Fluid Transfer LLC, Kilgore, TX (US)

(21) Appl. No.: 18/036,114

(22) PCT Filed: Sep. 30, 2021
(86) PCT No.: PCT/US21/52827

§ 371 Date: May 9, 2023

Related U.S. Application Data
(60) Provisional application No. 63/112,133, filed on Nov. 10, 2020.

(51) Int. Cl. F16L 47/02; F16L 47/32

(52) U.S. Cl. CPC F16L 47/02; F16L 47/32

(57) ABSTRACT

A system, apparatus, and method for making and implementing non-metallic fittings with non-metallic tubulars for high-pressure fluid transport. The apparatus includes a fitting formed from a body of non-metallic material that is tunneled and configured to receive non-metallic tubulars at standard and custom angles. The system includes multiple non-metallic tubulars and fittings that can be arranged at standard and custom angles, and, in some instances, be customized by pressure along the length of the transport line. Some of the fittings in the system can be hot-tapped. The methods include manufacture of the fittings and system and performing calculations to achieved selected pressure ratings.

### BACKGROUND OF THE DISCLOSURE

### 1. Field of the Disclosure

This disclosure relates to non-metallic fittings and methods of their manufacture and use in transporting liquids and gasses.

### 2. Description of the Related Art

Transporting fluids (either as gasses or liquids), such as water and chemicals can be costly and time consuming, particularly when the fluids need to be transported while under pressure. High pressure fluid transportation is essential to hydrocarbon and chemical transportation, as well as, efficient oil and gas recovery techniques.

Traditional pipes used for transporting fluids, such as water, are made of steel or other metals, such as aluminum. More recent pipes are composed of a plastic material such as high-density polyethylene (HDPE). HDPE pipes have some advantages over metal pipes, including lower costs, abrasion resistance, corrosion resistance, high impact resistance and greater flexibility (which are especially useful over uneven terrains). These pipes are durable for gas, chemical and water applications and may be reused.

When a connection to another pipe needs to be made, fittings may be added to a series of pipes to allow the connection to be made, or the connection may be made to the pipe through a tapping operation the pipeline. A shortcoming of existing non-metallic wrapped pipe is that new connection points cannot be added directly in the pipe since the integrity of the fibers of the wrap are compromised when they are cut or otherwise worked after application. The reduction of integrity means that the pipe's operating pressure may be derated below a usable rating. One alternative is to use metal fittings to provide connection points for the additional HDPE pipe; however, this adds another shortcoming in that the mixing of HDPE and metallic pipe increases stress and integrity problems at the connection point due to unequal temperature expansion and contraction at the connection point. Thus, the pipe may again be derated or fail at the connection.

What is needed is a cost-effective HDPE piping connection and system that can, among other things, tolerate new connection points being added after installation that do not require fittings made of dissimilar materials with difference thermal expansion properties.

### BRIEF SUMMARY OF THE DISCLOSURE

In aspects, the present disclosure is related to a system and method for joining non-metallic pipe for transportation of fluids. Specifically, the present disclosure is related to joining non-metallic pipe joints using a non-metallic fitting that can be customized in the field, before and after installation.

One embodiment according to the present disclosure includes a non-metallic fitting that includes a non-metallic body; and a first tunnel through the body, the first tunnel having a first side and a second side; wherein a portion of the first tunnel is widened at each of the first side and the second side to form a shelf for receiving a tubular. The non-metallic body may be made mostly or completely from HDPE. The non-metallic body may be cylindrical, spherical, or any selected three-dimensional shape. The first tunnel may be straight, curved, or bend along its length. The widened portion of the first side of the first tunnel may have the same or a different diameter than the widened portion of the second side of the first tunnel. The fitting may have a second tunnel with an opening with a widened portion forming another shelf for receiving another tubular, where the second tunnel intersects the first tunnel at an angle of 90 degrees or some other angle between 0 and 180 degrees. The widened portion of the second tunnel had a diameter that is different from a diameter of the widened portion of the first side of the first tunnel.

Another embodiment of the present disclosure includes a method for manufacturing a fitting, including the steps of: forming a first tunnel in a body of nonmetallic material, the first tunnel having a first center line; determining an angle for a second tunnel in the body; and forming the second tunnel in the body, the second tunnel having a second center line that is offset from the first center line by the angle. The first tunnel may extend partially or completely through the body. The second tunnel may intersect the first tunnel. The method may also include the steps of: forming at least one shelf in the first tunnel by widening a portion of the first tunnel at its opening; and forming a shelf in the second tunnel by widening a portion of the second tunnel at its opening. The at least one shelf in the first tunnel may have a width corresponding to the wall thickness of a selected first tubular, and the shelf in the second tunnel may have a width corresponding to the wall thickness of a selected second tubular. Each of the shelves may be recessed from its corresponding opening by a selected depth, where the selected depth is based on an estimated desired pressure rating for the fitting.

Another embodiment of the present disclosure includes a non-metallic pipe system that includes a plurality of non-metallic tubulars; a non-metallic fitting welded to at least one of the plurality of non-metallic tubulars; wherein the non-metallic fitting includes: a non-metallic body; and a first tunnel through the body, the first tunnel having a first side and a second side, wherein a portion of the first tunnel at each of the first side and the second side is widened to form a shelf for receiving one of the plurality of non-metallic tubulars. The system may include a non-metallic valve connected to at least one of the plurality of non-metallic tubulars and in fluid communication with the non-metallic fitting.

Another embodiment of the present disclosure includes a method of making a non-metallic pipe system, including the steps of: estimating a maximum wrap thickness for a non-metallic pipe joint to meet a minimum pressure rating requirement for a non-metallic pipe joint; estimating a pressure decline with distance from a pressure source; estimating a wrap thickness for each of a plurality of non-metallic pipe joints based on the pressure decline; wrapping each of the plurality of non-metallic pipe joints to the estimated wrap thickness; and assembling the non-metallic pipe joints in order of descending wrap thickness. The method may also include an additional step of: installing at least one non-metallic fitting between two of the plurality of non-metallic pipe joints, wherein the at least one non-metallic fitting includes: a non-metallic body; and a first tunnel through the body, the first tunnel having a first side and a second side, wherein a portion of the first tunnel at each of the first side and the second side is widened to form a shelf for receiving one of the plurality of non-metallic tubulars. The method may also include forming the second tunnel in the body that intersects the first tunnel. The method may also include determining an angle of the second tunnel relative to the first tunnel prior to forming the second tunnel. The second tunnel may have a widened portion at its opening with a shelf for receiving a tubular. The second tunnel may be formed while the first tunnel is pressurized or filled with fluid.

Another embodiment of the present disclosure includes a system of non-metallic piping including: a plurality of non-metallic pipe joints, each including: a pipe core; and a fiber tape wrap layer surrounding the pipe core; wherein a thickness of the fiber tape wrap layer is estimated based on a selected pressure rating, and wherein each successive non-metallic pipe joint in a series has a lower selected pressure rating based on the pipe distance of the pipe joint from a pressure source. In some embodiments, some or all of the non-metallic pipe joints may have a sheath that surrounds the fiber tape wrap layer. Interposed between at least two of the non-metallic pipe joints, there may a non-metallic fitting between two of plurality of non-metallic pipe joints, wherein the at least one non-metallic fitting includes: a non-metallic body; and a first tunnel through the body, the first tunnel having a first side and a second side, wherein a portion of the first tunnel at each of the first side and the second side is widened to form a shelf for receiving one of the plurality of non-metallic tubulars. The non-metallic fitting may have a second tunnel intersecting the first tunnel; and the system may include a lateral tubular directly connected to an opening of the second tunnel.

Examples of the more important features of the disclosure have been summarized rather broadly in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1A is a diagram of a three-way non-metallic fitting according to the present disclosure;

FIG. 1B is a 3D view of the diagram in FIG. 1A;

FIG. 2 is a diagram of a three-way non-metallic fitting with a non-right angle according to the present disclosure;

FIG. 3A is a diagram of a two-way angled fitting joined to a pipe segment according to the present disclosure;

FIG. 3B is a diagram of connection between the pipe segment and the non-metallic fitting in FIG. 3A according to the present disclosure;

FIG. 4 is a flow chart for a method of fabricating a fitting of the type of FIGS. 1A-2 and joining tubulars according to the present disclosure;

FIG. 5 is a flow chart for a method of fabricating a fitting of the type of FIG. 3 and joining tubulars according to the present disclosure;

FIG. 6A is a diagram of a system of pipe segments and cylindrical fittings with the branching segments in a horizontal plane according to the present disclosure;

FIG. 6B is a diagram of another system of pipe segments and cylindrical fittings with the branching segments in vertical planes according to the present disclosure;

FIG. 6C is a diagram of a system of pipe segments, a valve and spherical fittings according to the present disclosure;

FIG. 7 is a flow chart for a method of fabricating a system of pipes with decreasing pressure rating as the distance from the pressure source increases according to the present disclosure; and

FIG. 8 is a diagram of the fabricated system of pipes with decreasing pressure rating of the method of FIG. 7.

### DETAILED DESCRIPTION OF THE DISCLOSURE

Generally, the present disclosure relates to systems and methods for joining non-metallic pipe joints. Specifically, the joining of non-metallic pipe joints using a non-metallic custom fitting that can be configured to form standard and non-standard connections. The present disclosure is susceptible to embodiments of different forms. There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

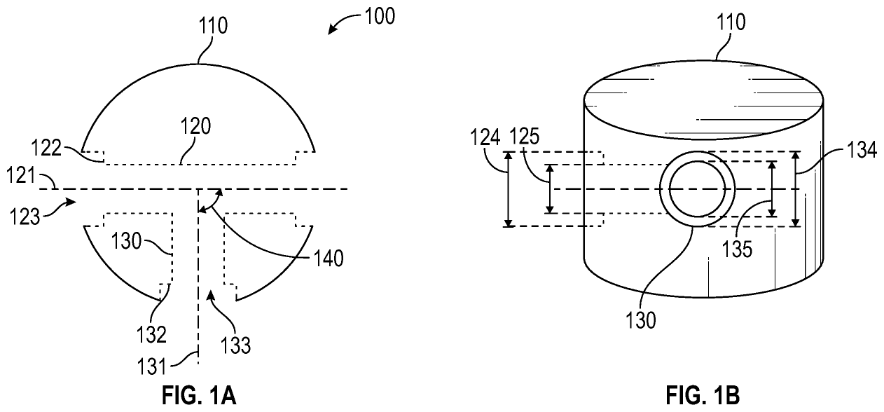

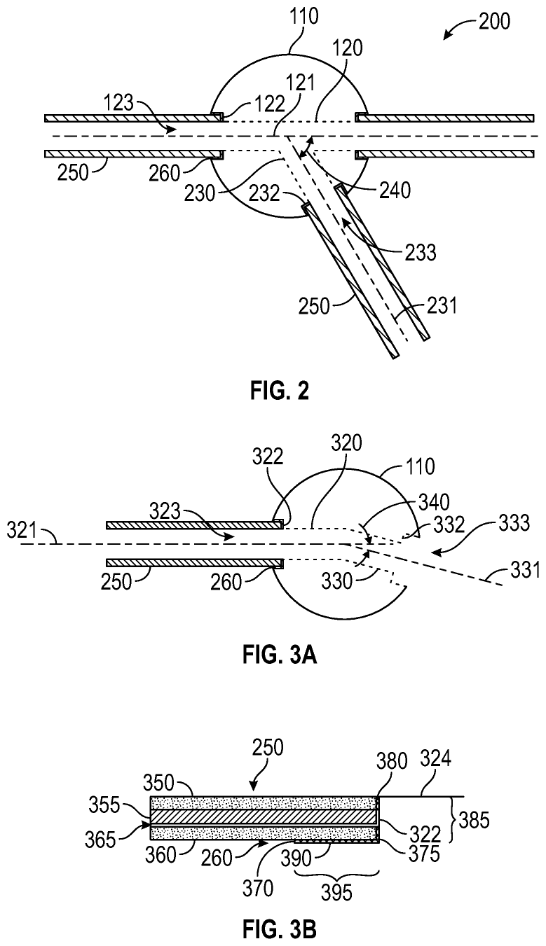

FIG. 1A shows a diagram of a three-way non-metallic fitting 100 according to one embodiment of the present disclosure. The fitting 100 includes a body 110. The body may be a semi-finished casting, such as a billet. The body 110 may be any shape, including cylindrical and spherical. The body 110 may be made of a non-metallic material, such as high-density polyethylene (HDPE), or any suitable thermoplastic pipe, as would be understood by a person of ordinary skill in the art. The body 110 may include a first tunnel 120 with a first center line 121. The tunnel 120 may include a shelf 122 that is broadens that an opening 123 to a larger diameter than the first tunnel 120. The opening 123 and the shelf 122 may be on both sides of the first tunnel 120 in the body 110. The fitting 100 may also include a second tunnel 130 that intersects the first tunnel 120. The second tunnel 130 may have a second centerline 121. The second tunnel 130 may have a second shelf 132 that broadens a second opening 133 to a larger diameter than the second tunnel 130. In some embodiments, the shelves 122, 132 may be present so that a tubular (such as tubular 250 in FIG. 2) may be butt welded to the fitting 100. An angle 140 is shown between the first centerline 121 and the second centerline 131 to indicate that figure shows a right angle or T-intersection. This angle 140 is only a right angle for illustration, and the angle 140 may be selected by varying the centerlines 121, 131 in relation to one another. This variation may include manufacturing the tunnels 120, 130 in the body 110 to form different angles 140. The body 110 is selected with suitable excess material such that it will retain suitable strength to achieve a preselected minimum pressure rating after the tunnels 120, 130 and shelves 122, 132 are formed.

FIG. 1B shows a 3-dimensional representation of the fitting 100 from FIG. 1A. The body 110 is shown as cylindrical, but this shape is exemplary and illustrative, as the body may be spherical or any other shape that can be formed with HDPE. Width 124 of the opening 123 shows the largest outer diameter of tubular that may be received into the fitting 100 at the first tunnel 121. Width 125 shows the diameter of the tunnel 121. Likewise, width 134 of the opening 133 shows the largest outer diameter of tubular that may be received into the fitting 100 at the second tunnel 131, and width 135 shows the diameter of the tunnel 131. In some embodiments, the width 124 and the width 134 may be the same or different. In some embodiments, the width 125 and the width 135 may be the same or different. In some embodiments, every opening, even sharing the same centerline, may have different diameters, while in other embodiments, every opening may have the same diameters.

The body 110 is selected with suitable excess material such that it will retain suitable strength to achieve a preselected minimum pressure rating after the tunnels 120, 130 and shelves 122, 132 are formed. In one exemplary embodiment, where the desired minimum pressure rating is 750 psig (5.2 MPa), the body 110 may be made of HDPE and be cylindrical with a circular diameter of 28 inches and a height of 26 inches with the tunnels 120, 130 having interior diameters of 11.5 inches (29.2 cm) and outer diameters (corresponding to the openings 123, 133) of 14 inches (35.6 cm) for connecting tubulars with a wall thickness of 1.25 inches (32 mm) (corresponding to to the fitting.

FIG. 2 shows a three-way angled fitting 200 formed in the body 110. The fitting 100 includes the first include the first tunnel 120 with the first center line 121, the shelves 122, and the openings 123 of FIG. 1A; however, a second tunnel 230 is formed in the body 110 at an angle 240 that is not a right angle. The second tunnel 230 includes a second centerline 231 that intersects the first centerline 121 at the angle 240. The second tunnel 230 includes a shelf 232 to broaden the second tunnel into an opening 233 in the body 110, so that a tubular may be butt welded into the body 110. As shown, tubulars 250 may be received into the openings 123 and welded to the body 110. In some instances, welding may include butt welding at least part of an end of the tubular 250 to the shelf 122 and socket welding the part of the exterior of the tubular 250 to the body 110 at one of the openings 123. The openings 123, 233 may be slightly larger than the outer diameter of the tubular 250 to make room for weld material 260 to form the socket weld. Similarly, another tubular 250 may be received into the opening 233 and a similar welding connection formed. In some instances, different diameters of tubulars 250 may be received by correspondingly sized openings 123, 233. The tubulars 250 may be made non-metallic materials. In some instances, the tubulars 250 may be made of composite pipes formed of a thermoplastic, such as HDPE, pipe and reinforced by an outer fiber tape wrap. The fiber tape wrap may be made of a similar material to the HDPE pipe, such as a high-density polyethylene thermoplastic tape, but any suitable wrap may be used, as would be understood by a person of ordinary skill in the art. The fiber tape wrap may include continuous fibers, such as a fiberglass HDPE tape manufactured by Ticona Engineering Polymers under the brand name Celstran (TM) (Model no. CFR-TP HDPE GF70-01). In one embodiment, the tape is made of 70 percent fiberglass by weight and is a foot in width. Other widths such as 6 inches are contemplated. The fibers are continuously run (uni-directional) along the tape and are taut. In some embodiments, the tubular 250 may also include an outer HDPE sheath surrounding the fiber tape wrap layer.

FIG. 3A shows a diagram of two-way fitting 300 according to one embodiment of the present disclosure. The fitting 300 includes the body 110 with a first tunnel 320 extending to about the center of the body 110. A second tunnel 330 extends about the center of the body 110 where it meets with the first tunnel 320. The first tunnel 320 has a first center line 321, and the second tunnel 330 has a second center line 331. The first centerline 321 and the second center line 331 form an angle 340. The angle may be selected by the formation of the first tunnel 320 and the second tunnel 330 to be anywhere from 0 degrees to almost 180 degrees. The first tunnel 320 may include a shelf 322 so that it broadens into an opening 323 that can receive a tubular 250 for formation of butt and socket welds. Likewise, the second tunnel 330 may include a shelf 332 so that it broadens into an opening 333 that can receive another tubular for formation of a socket weld.

As shown, a tubular 250 may be received into the opening 323 and socket welded. The opening 323 may be slightly larger than the outer diameter of the tubular 250 to make room for weld material 260 to form the socket weld. While FIGS. 1A-3 shows two- and three-way connections, this is illustrative and exemplary only, as any number of connections may be added to a fitting 100, 200, 300 by increasing the number of tunnels in the fitting body 110.

FIG. 3B shows a close-up of the weld connection 260 between the tubular 250 and the fitting body 110 at the opening 323 from FIG. 3A. This weld connection 260 is suitable for all of the embodiments. The tubular 250 has an HDPE core pipe 350 surrounded by a fiber tape wrap layer 355. The fiber tape wrap layer 355 may be surrounded by an optional outer sheath 360 to protect the fiber tape wrap layer 355 from wear and damage. The outer sheath 360 may be made of HDPE. In some embodiments, an annular gap 365 may exist between the inside of the outer sheath 360 and the outside of the fiber tape wrap layer 355. The weld connection 260 is made up of three weld zones—a socket weld 370 between the outer sheath 360 and the inside wall 390 of the opening 323, a butt weld 375 between an end of the outer sheath 360 and the shelf 322, and a butt weld 380 between an end of the pipe 350 and the shelf 322. The shelf 322 is perpendicular to the tunnel wall 324 and has a width 385 that is sized to allow the ends of the pipe 350 and outer sheath 360 to be butt welded to the shelf 322. The inside wall 390 has a depth 395 that is deep enough for the socket weld 370 to be formed and such that enough of the material of the body 110 is present to safely maintain the desired pressure rating of the fitting 300 once the tubular 250 has been connected.

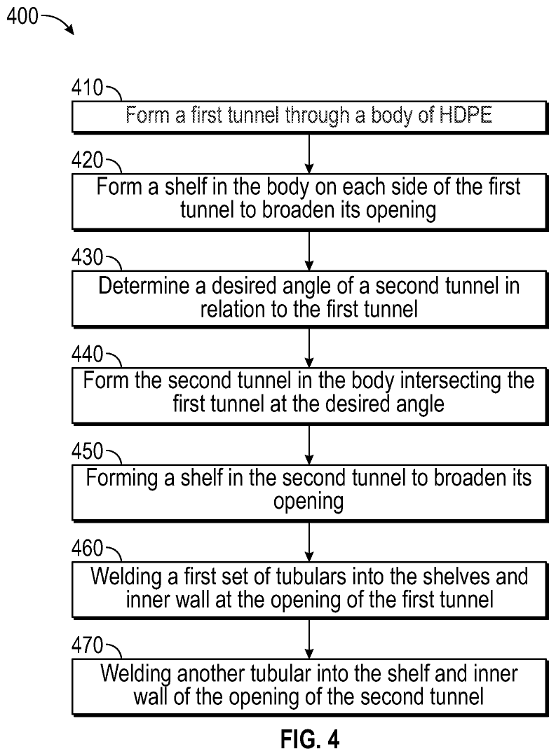

FIG. 4 shows a method 400 for forming a fitting 100, 200 and joining to tubulars according to one embodiment of the present disclosure. In step 410, the first tunnel 120 may be formed in the body 110. The first tunnel 120 has a first center line 121 and may be formed by drilling, boring, cutting, or any other suitable techniques known to a person of skill in the art. In some embodiments, step 410 is optional, as the body 110 may be obtained with the first tunnel 120 already premanufactured. In step 420, a shelf 122 may be formed in the body 110 at each of the openings 123 of the first tunnel 120 by broadening the diameter of the opening 123. In step 430, the angle 140, 240 may be determined for the second tunnel 130, 230. The angle 140, 240 may be determined by based on actual or designed positions of tubulars for which the fitting 100, 200 is being installed. In step 440, the second tunnel 130, 230 may be formed in the body 110. The second tunnel 130, 230 has a second center line 131, 231 that is at the angle 140, 240 in relation to the first center line 121. In step 450, a shelf 132, 232 may be formed in the body 110 at the opening 133, 233 of the second tunnel 130, 230. The second tunnel 130, 230 and the second shelf 132, 232 may be formed using the same or a different technique as the first tunnel 120 and the first shelves 122 (i.e. drilling, boring, cutting, etc.). In step 460, a tubular 250 may be welded into one of the openings 123. The same operation may then be performed for the other opening 123. The welding operation of step 460 may form the butt welds 375, 380 and socket weld 370 shown in FIGS. 3A-3B. In step 470, another tubular 250 may be welded into the second opening 233, again forming the butt welds 375, 380 and socket weld 370 shown in FIGS. 3A-3B. In some embodiments, these steps may be performed in a different order. For example, steps 410, 420, and 460 may be performed before the steps 430-450 and 470. In some embodiments, the steps 410, 420, and 460 may be performed and the tubulars placed in service before steps 430-450 and 470 are performed. A significant advantage of the method 400 is that steps 430-450 and 470 may be performed while a line made of tubulars 250 and fittings 100, 200 remains pressurized.

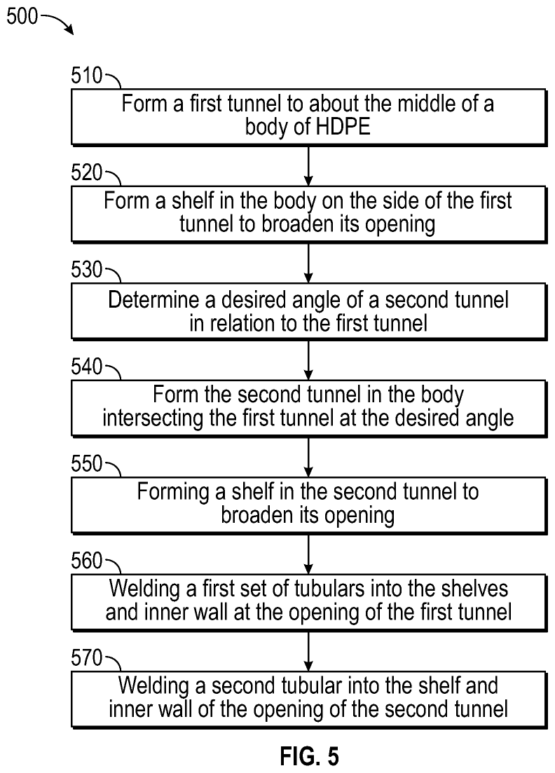

FIG. 5 shows a method 500 for forming a fitting 300 and joining to tubulars according to one embodiment of the present disclosure. In step 510, the first tunnel 320 may be formed in the body 110. In some embodiments, step 510 is optional, as the body 110 may be obtained with the first tunnel 320 already premanufactured. The first tunnel 320 has a first center line 321 and may be formed by drilling, boring, cutting, or any other suitable techniques known to a person of skill in the art. Unlike the first tunnel 120, the first tunnel 320 may stop approximately in the center of the body 110 rather than going completely through the body 110. In step 520, a shelf 322 may be formed in the body 110 at the opening 323 of the first tunnel 320 by broadening the diameter of the opening 323. In step 530, the angle 340 may be determined for the second tunnel 330. The angle 340 may be determined by based on actual or designed positions of tubulars for which the fitting 300 is being installed. In step 540, the second tunnel 330 may be formed in the body 110. The second tunnel 330 may have a second center line 331 that is at the angle 340 in relation to the first center line 321. In step 550, a shelf 332 may be formed in the body 110 at the opening 333 of the second tunnel 330. The second tunnel 330 and the second shelf 332 may be formed using the same or a different technique as the first tunnel 320 and the first shelf 322 (i.e. drilling, boring, cutting, etc.). In step 560, a tubular 250 may be welded to the body 110 at the first opening 323. The welding operation of step 560 may form the butt welds 375, 380 and socket weld 370 shown in FIGS. 3A-3B. In step 570, another tubular 250 may be welded into the second opening 233, again forming the butt welds 375, 380 and socket weld 370 shown in FIGS. 3A-3B. In step 570, another tubular 250 may be socket welded into the second opening 333. In some embodiments, these steps may be performed in a different order. For example, steps 510, 520, and 560 may be performed before the steps 530-550 and 570.

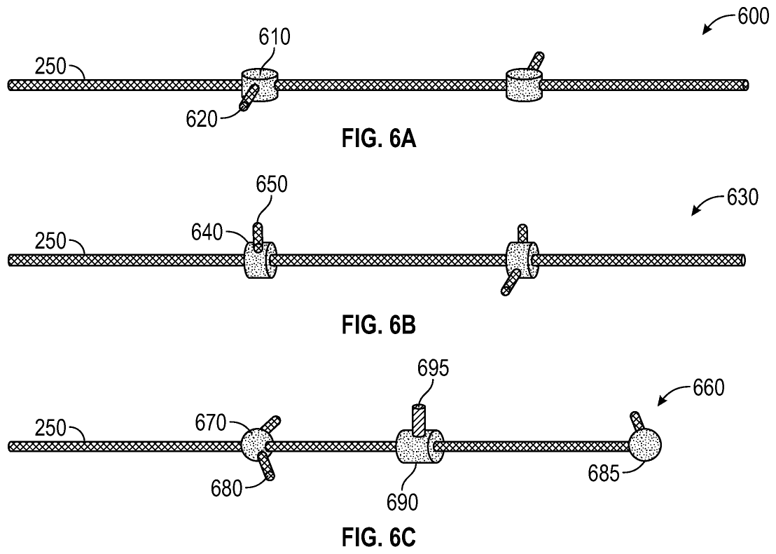

FIGS. 6A-6C show diagrams of different embodiments of piping systems using HDPE fittings as discussed above. FIG. 6A shows a diagram of a system 600 that includes a plurality of tubulars 250 connected to cylindrical fittings 610. The cylindrical fittings 610 are oriented so that the circular plane of the cylinder is facing a vertical direction. Another tubular 620 is laterally connected to the fitting 610. The tubular 620 may be made of the same material and have the same structure as the tubular 250. The tubular 620 may have the same or different dimensions than the tubular 250. FIG. 6B shows a diagram of a system 630 that includes a plurality of tubulars 250 connected to cylindrical fittings 640, which are oriented with the circular plane of the cylinder perpendicular to the tubulars 250. Another tubular 650 is laterally connected to the fitting 640 such that the tubular 650 longitudinally extends in a plane perpendicular to the tubulars 250, at least in proximity to the fitting 640. FIG. 6C shows a diagram of a system 660 that includes a plurality of tubulars 250 connected to spherical fittings 670. Lateral tubulars 680 are connected to the spherical fittings 670 and may branch out in a variety of directions, even directions that are not perpendicular to the tubulars 250. The lateral tubulars 620, 650, 680 may have the same or different inner and outer diameters as the tubulars 250. A two-way fitting 685 is shown at one end to form a bend in the system 660. The fitting 685 may be similar to the fitting 300. In some embodiments, the fitting 685 or similar may be used to as a substitute for an elbow in the tubular 250. The fitting 685 may be used to add strength at the bend against outside environmental stresses, provide for a custom angle, and/or reinforce the system 660 by acting as a thrust block to prevent pipe leaks and separations at points in the system 660 that may be subject to stresses caused by the fluid being transported. A non-metallic valve 690 is shown disposed between the spherical fittings 670. The valve 690 may be made of HDPE and is equipped with a valve stem 695 for actuation of the valve 690. The valve 690 may have a non-metallic body and a non-metallic stem 695. The valve 690 may be of any type suitable for pipe operation, including, but not limited to, ball valves, butterfly valves, and check valves. In some embodiments, the body of the valve 690 may be a cylindrical or spherical billet used in the body 110. In some embodiments, the valve 690 may have a body made of multiple parts that can be separate to allow access to the interior of the valve 690 for maintenance and repair operations. One exemplary and non-limiting example of the valve 690 is an HDPE TimeSaver valve manufactured by P.E. Valve, LLC in Conroe, Texas.

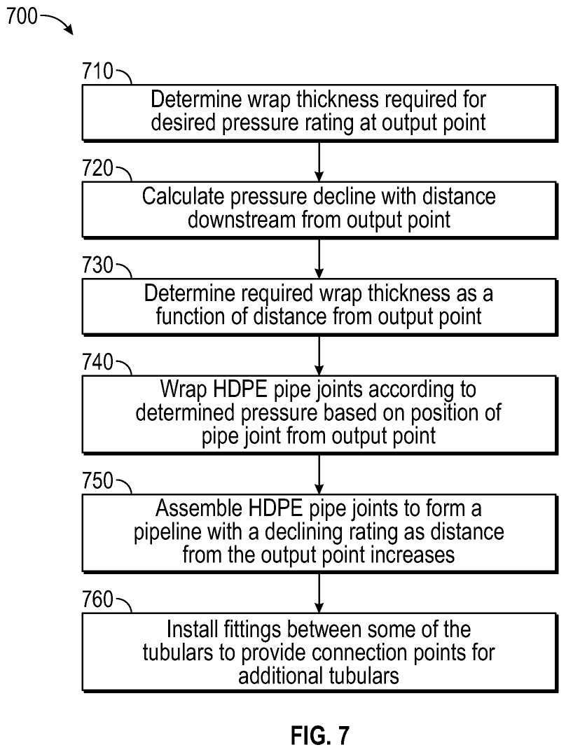

FIG. 7 shows a flow chart of a method 700 for building a pipeline with variable pressure ratings according to the present disclosure. In step 710, one or more calculations or design decisions are made to estimate the thickness for a non-metallic tubular that correspond to a desired pressure rating for the maximum pressure output of a fluid source at its output point as would be understood by a person of ordinary skill in the art. The thickness may be provided by a wall thickness of the HDPE pipe or a combination of the wall thickness of the HDPE pipe and a fiber tape wrap reinforcing the HDPE pipe. In step 720, the pressure decline relative to distance from the pressure output is estimated. In step 730, a tubular thickness is estimated to correspond with the declining pressure rating required as distance from the pressure output decreases. In step 740, tubulars are wrapped to the estimated wrap thickness, such that the combined HDPE pipe wall thickness combined with the wrap thickness provides sufficient strength to meet the selected pressure rating. Since the amount of wrap required will decline as distance from the pressure source increases, the amount of material (usually in the form of fiber tape) per unit length of tubular will decrease with distance from the pressure source. This means that the cost of materials, preparation time for the length tubular, and weight of materials will also decline with distance, unlike a pipe system where all pipes have a uniform pressure rating. In step 750, the tubulars are assembled in proper order to ensure that the pressure rating declines within distance from the pressure source. In step 760, fittings may be added between some of the tubulars to provide present or future connection points for additional tubulars. In some embodiments, steps 750 and 760 are performed together.

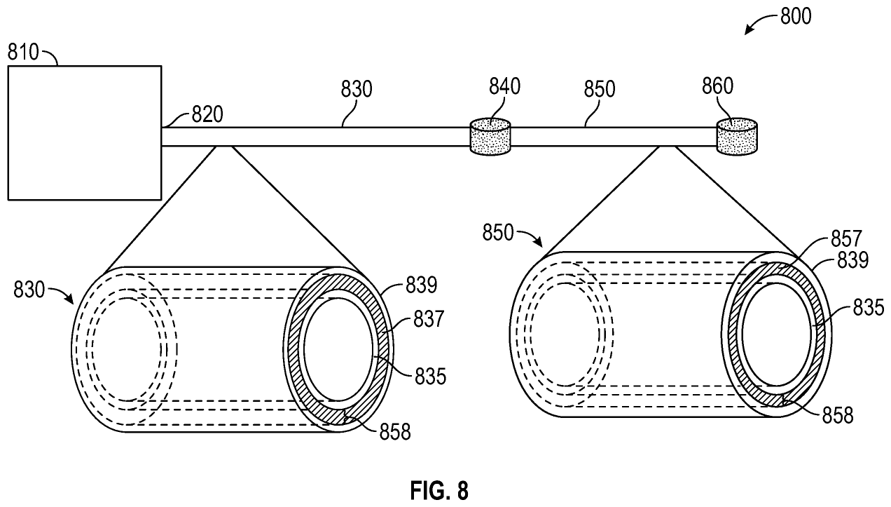

FIG. 8 shows a diagram of a piping system 800 according to one embodiment of the present disclosure. The piping system 800 includes a tubular 830 that may be in fluid communication with a pressure source 810, such as a high-pressure tank, motorized compressor, a hydrocarbon well, or other fluid pressurized output as would be understood by a person of ordinary skill in the art. The output point 820 of the pressure source 810 is where the tubular 830 of the piping system 800 connects to the pressure source 810. The output point 820 is also the location where the pressure is estimated to be the highest in the piping system 800, and, thus, the tubular 830 needs to have the highest minimum pressure rating. One or more additional tubulars 850 may be in fluid communication and downstream of the tubular 830. The tubulars 830, 850 may be connected to one another or have an intervening fitting 840. The fitting 840 may be one of the fittings 100, 200, 300. The fitting 840 may be disposed along the tubulars 830, 850 to provide a present or future connection point where a lateral tubular (not shown) may be connected, such as in FIGS. 6A-6C.

The tubular 830 is shown as a composite pipe made up of a non-metallic pipe 835 surrounded by a fiber tape wrap layer 837 with a thickness 838. The tubular 830 has an outer sheath 839 of non-metallic pipe material, optional, to protect the fiber tape wrap layer 837. The tubular 850 is downstream of the tubular 830. The tubular 850 includes the non-metallic pipe 835 surrounded by a fiber tape wrap 857. The tubular 850 has an outer sheath 859 of non-metallic pipe material, optional, to protect the fiber tape wrap layer 857. The fiber tape wrap layer 857 has a thickness 858 that is less than the thickness 838 because the tubular 850 is disposed downstream of the tubular 830, and, thus, is exposed to a lower pressure than the tubular 830.

While the disclosure has been described with reference to exemplary embodiments, it will be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A non-metallic fitting comprising:
a non-metallic body; and
a first tunnel through the body, the first tunnel having a first side and a second side;
wherein a portion of the first tunnel is widened at each of the first side and the second side to form a shelf for receiving a tubular.

2. The fitting of claim 1, wherein the non-metallic body is made of HDPE.

3. The fitting of claim 1, wherein the non-metallic body is cylindrical.

4. The fitting of claim 1, wherein the first tunnel is straight.

5. The fitting of claim 1, wherein the widened portion of the first side of the first tunnel has a different diameter than the widened portion of the second side of the first tunnel.

6. The fitting of claim 1, further comprising a second tunnel having an opening with a widened portion forming another shelf for receiving another tubular.

7. The fitting of claim 6, wherein the second tunnel intersects the first tunnel at an angle other than 90 degrees.

8. The fitting of claim 6, wherein the widened portion of the second tunnel has a diameter that is different from a diameter of the widened portion of the first side of the first tunnel.

9. A method of making a fitting, the method comprising:
forming a first tunnel in a body of nonmetallic material, the first tunnel having a first center line;
determining an angle for a second tunnel in the body; and
forming the second tunnel in the body, the second tunnel having a second center line that is offset from the first center line by the angle.

10. The method of claim 9, wherein the first tunnel extends completely through the body.

11. The method of claim 9, wherein the second tunnel intersects the first tunnel.

12. The method of claim 9, further comprising the steps of:
forming at least one shelf in the first tunnel by widening a portion of the first tunnel at its opening; and
forming a shelf in the second tunnel by widening a portion of the second tunnel at its opening.

13. The method of claim 12, wherein the at least one shelf in the first tunnel has a width corresponding to the wall thickness of a selected first tubular, and where the shelf in the second tunnel has a width corresponding to the wall thickness of a selected second tubular.

14. The method of claim 12, wherein each of the shelves is recessed from its corresponding opening by a selected depth, where the selected depth is based on an estimated desired pressure rating for the fitting.

15. A system of non-metallic piping comprising:
a plurality of non-metallic tubulars;
a non-metallic fitting welded to at least one of the plurality of non-metallic tubulars;
wherein the non-metallic fitting comprises:
a non-metallic body; and
a first tunnel through the body, the first tunnel having a first side and a second side,
wherein a portion of the first tunnel at each of the first side and the second side is widened to form a shelf for receiving one of the plurality of non-metallic tubulars.

16. The system of claim 15, further comprising:
a non-metallic valve connected to at least one of the plurality of non-metallic tubulars and in fluid communication with the non-metallic fitting.

17. A method of making a non-metallic pipe system, comprising the steps of:
estimating a maximum wrap thickness for a non-metallic pipe joint to meet a minimum pressure rating requirement for a non-metallic pipe joint;
estimating a pressure decline with distance from a pressure source;
estimating a wrap thickness for each of a plurality of non-metallic pipe joints based on the pressure decline;
wrapping each of the plurality of non-metallic pipe joints to the estimated wrap thickness; and
assembling the non-metallic pipe joints in order of descending wrap thickness.

18. The method of claim 17, further comprising the step of:
installing at least one non-metallic fitting between two of the plurality of non-metallic pipe joints, wherein the at least one non-metallic fitting comprises:
a non-metallic body; and
a first tunnel through the body, the first tunnel having a first side and a second side,
wherein a portion of the first tunnel at each of the first side and the second side is widened to form a shelf for receiving one of the plurality of non-metallic tubulars.

19. The method of claim 18, further comprising the step of:
forming the second tunnel in the body that intersects the first tunnel.

20. The method of claim 19, further comprising the step of:
determining an angle of the second tunnel relative to the first tunnel prior to forming the second tunnel.

21. The method of claim 19, wherein the second tunnel has a widened portion at its opening with a shelf for receiving a tubular.

22. The method of claim 19, wherein the second tunnel is formed while the first tunnel is pressurized or filled with fluid.

23. A system of non-metallic piping comprising:
a plurality of non-metallic pipe joints, each comprising:
a pipe core; and
a fiber tape wrap layer surrounding the pipe core;
wherein a thickness of the fiber tape wrap layer is estimated based on a selected pressure rating, and wherein each successive non-metallic pipe joint in a series has a lower selected pressure rating based on the pipe distance of the pipe joint from a pressure source.

24. The system of claim 23, wherein at least some of the plurality of non-metallic pipe joints further comprise:
a sheath that surrounds the fiber tape wrap layer.

25. The system of claim 23, further comprising:
at least one non-metallic fitting between two of plurality of non-metallic pipe joints, wherein the at least one non-metallic fitting comprises:
a non-metallic body; and
a first tunnel through the body, the first tunnel having a first side and a second side,
wherein a portion of the first tunnel at each of the first side and the second side is widened to form a shelf for receiving one of the plurality of non-metallic tubulars.

26. The system of claim 25, wherein the at least one non-metallic fitting further comprises:
a second tunnel intersecting the first tunnel; and
the system further comprises:
a lateral tubular directly connected to an opening of the second tunnel.
